(19) United States
(12) Patent Application Publication
(10) Pub. No.: US 2014/0102401 A1
(43) Pub. Date: Apr. 17, 2014

(54) CYLINDER LINER AND STRUCTURAL UNIT CONSISTING OF AT LEAST ONE CYLINDER LINER AND A CRANKCASE

(71) Applicant: Wolfgang Issler, Schwaikheim (DE)

(72) Inventor: Wolfgang Issler, Schwaikheim (DE)

(73) Assignee: MAHLE INTERNATIONAL GMBH, Stuttgart (DE)

(21) Appl. No.: 14/118,903

(22) PCT Filed: May 19, 2012
(86) PCT No.: PCT/DE2012/000527

§ 371 Date: Nov. 20, 2013

(30) Foreign Application Priority Data
May 21, 2011 (DE) 10 2011 102 203.5

(51) Int. Cl. F02F 1/00

(52) U.S. Cl. CPC F02F 1/004
USPC 123/193.2

(57) ABSTRACT

The invention relates to a cylinder liner (30, 130) for a cylinder crankcase (11, 12; 111, 112) of an internal combustion engine, characterized in that at least a portion of the outer peripheral surface (34, 134) of the cylinder liner (30, 130) is surrounded by a sleeve (35, 235) that is produced of a metal material. The present invention further relates to a structural unit (10, 110) that consists of at least one such cylinder liner (30, 130) and a cylinder crankcase (11, 12; 111, 112).

The present invention relates to a cylinder liner for a cylinder crankcase of an internal combustion engine. The present invention furthermore relates to a structural unit consisting of at least one cylinder liner and a cylinder crankcase for an internal combustion engine, having at least one coolant space assigned to the at least one cylinder liner.

In internal combustion engines, a distinction is made between “wet” and “dry” cylinder liners. In the case of wet cylinder liners, a coolant space is integrated into the cylinder crankcase and configured between the cylinder crankcase and the cylinder liner. In this connection, the danger exists that the cylinder liner, which stands in direct contact with the coolant, will be damaged as the result of cavitation in the coolant. Cavitation is caused, for example, as the result of high-frequency vibrations that are produced by the gas forces in the combustion chamber and the impact pulses during lateral piston movement. These high-frequency vibrations are particularly transmitted to the coolant by way of the cylinder liner. In this connection, the extreme pressure and temperature peaks that are typical for cavitation cause damage in the material of the cylinder liner, particularly in the outer mantle surface. This danger particularly exists if the cylinder liner is produced from a cast-iron material, because this material has a comparatively non-homogeneous structure due to the graphite inclusions (nodular graphite or flake graphite). This non-homogeneous structure is particularly susceptible to such extreme pressure and temperature peaks, so that material particles can break out of the cylinder liner. From this, a hole can develop in the cylinder wall, through which coolant can exit in the direction of the combustion chamber.

The present invention is therefore based on the task of further developing a cylinder liner of the stated type or a structural unit of the stated type, consisting of at least one cylinder liner and a cylinder crankcase, in such a manner that the danger of cavitation damage is at least reduced.

The solution consists in that at least a partial region of the outer mantle surface of the cylinder liner is surrounded by a sleeve that consists of a metallic material. An object of the present invention is furthermore a structural unit consisting of at least one cylinder liner and a cylinder crankcase, wherein at least a partial region of the outer mantle surface of the cylinder liner is surrounded by a sleeve that consists of a metallic material, facing the at least one coolant space.

The embodiment according to the invention is characterized in that the outer mantle surface of the cylinder liner is protected against cavitation damage, at least locally, by a sheath consisting of a cavitation-resistant material. Damage to the cylinder liner according to the invention or to the structural unit according to the invention as the result of cavitation is thereby clearly reduced.

Advantageous further developments are evident from the dependent claims.

It is practical if the entire outer mantle surface of the cylinder liner is surrounded by a sleeve consisting of a metallic material, in order to optimize the protection against cavitation damage. A sleeve consisting of a steel material is particularly resistant to the extreme pressure and temperature impacts that occur during cavitation.

The sleeve provided according to the invention protects cylinder liners that consist of a cast iron material, in particular, against cavitation damage.

The sleeve provided according to the invention can be shrunk onto the outer mantle surface of the cylinder liner, in known manner, or can be molded onto the outer mantle surface of the cylinder liner.

If the sleeve surrounds at least a partial region of the outer mantle surface of the cylinder liner, it is advantageous. if ends flush with the outer mantle surface of the cylinder liner, in order to produce a smooth outer surface.

Exemplary embodiments of the invention will be described in greater detail in the following, using the attached drawings. These show, in a schematic representation not true to scale:

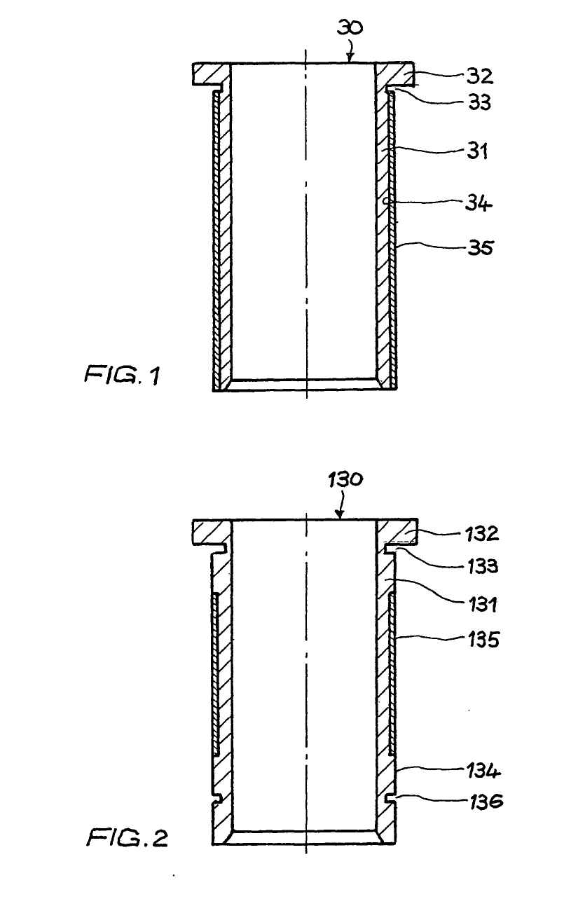

FIG. 1 a first exemplary embodiment of a cylinder liner according to the invention, in section;

FIG. 2 a further exemplary embodiment of a cylinder liner according to the invention, in section;

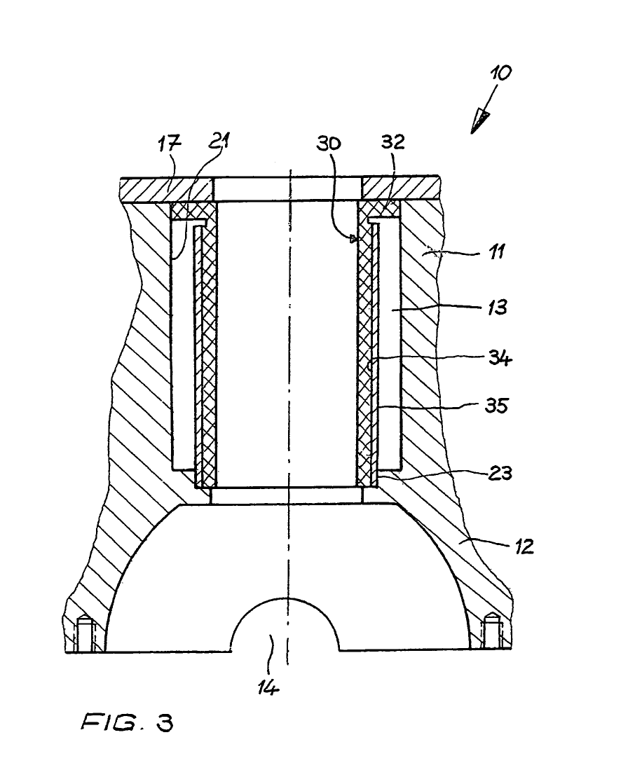

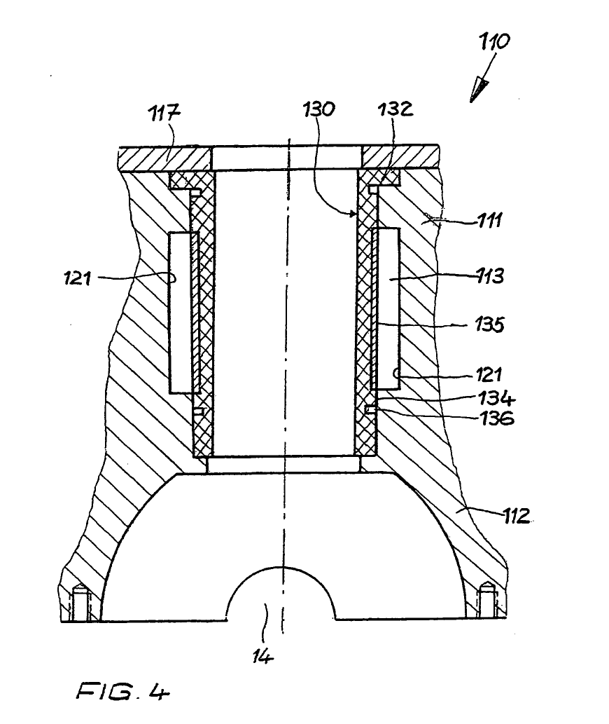

FIG. 3 a structural unit according to the invention, having the cylinder liner according to FIG. 1, in a partial representation, in section;

FIG. 4 a structural unit according to the invention, having the cylinder liner according to FIG. 2, in a partial representation, in section.

FIG. 1 shows a first exemplary embodiment of a cylinder liner 30 according to the invention. In the exemplary embodiment, the cylinder liner 30 consists, in known manner, of a cast-iron material, and can be produced using the centrifugal casting method, for example. In the exemplary embodiment, the cylinder liner 30 has a shaft 31 having a circumferential flange 32. Below the flange 32, a circumferential fillet 33 is provided in the shaft 31. The outer mantle surface 34 of the shaft 31 is surrounded, according to the invention, by a sleeve 35, which is produced from a steel material in the exemplary embodiment. In the exemplary embodiment, the sleeve 35 is pushed onto the shaft 31 after the cylinder liner 30 has been machine-finished, and is fixed in place in known manner, by means of shrink fit.

FIG. 2 shows a first exemplary embodiment of a cylinder liner 130 according to the invention. In the exemplary embodiment, the cylinder liner 130 also consists of a cast-iron material. In the exemplary embodiment, the cylinder liner 130 has a shaft 131 having a circumferential flange 132. Below the flange 132, a circumferential fillet 133 is provided in the shaft 131. A circumferential groove 136 is provided in the lower region of the shaft 131. The outer mantle surface 134 of the shaft 131 is partly surrounded, according to the invention, by a sleeve 135, which is produced from a steel material in the exemplary embodiment. In the exemplary embodiment, the sleeve 135 is laid into the casting mold for the cylinder liner 130 and molded onto the cylinder liner 130, in known manner. After machine finishing of the cylinder liner 130, a smooth outer surface is obtained, which is formed by the sleeve 135 and the exposed regions of the outer mantle surface 134, whereby the sleeve 135 ends flush with the mantle surface 134.

FIG. 3 shows a first exemplary embodiment of a structural unit 10 according to the invention for an internal combustion engine. The structural unit 10 has an upper cylinder housing 11 and a lower crankcase 12 that borders on the former. The cylinder housing 11 and the crankcase 12 preferably consist, in known manner, of a light-metal alloy on the basis of aluminum or magnesium, or of a cast-iron alloy. At least one cylinder liner 30 according to FIG. 1 is inserted into the cylinder housing 11. In the exemplary embodiment, the cylinder liner 30 is centered in the cylinder housing 11 by means of a step 23. The pistons that slide in the cylinder liners 30 are connected with a crankshaft by way of a connecting rod, in known manner (not shown). In this connection, the crankshaft is mounted in bearing locations 14 configured in the crankcase 12.

To cool the cylinder liner 30 during operation, a coolant space 13 that surrounds the cylinder liner 30 is provided in the cylinder housing 11. This coolant space 13 is configured directly in the cylinder housing 11, in the form of a recess, and surrounds the cylinder liner 30 along almost its entire axial height. According to the invention, the coolant present in the coolant space 13 stands in direct contact with the sleeve 35 that surrounds the outer mantle surface 34 of the cylinder liner 30. The sleeve 35 and the inner mantle surface 21 of the coolant space 13 delimit the latter in the radial direction. The coolant space is sealed off toward the top by means of the flange 32 and a cylinder head lid 17.

FIG. 4 shows a further exemplary embodiment of a structural unit 110 according to the invention for an internal combustion engine. The structural unit 110 essentially corresponds to the structural unit 10 according to FIG. 3, so that the same structural elements are provided with the same reference symbols, and in this regard, reference is made to the figure description relating to FIG. 3. The structural unit 110 also has an upper cylinder housing 111 and a lower crankcase 112 that borders on the former. At least one cylinder liner 130 according to FIG. 2 is inserted into the cylinder housing 111. In the exemplary embodiment, the cylinder liner 130 is centered in the cylinder housing 111 by means of a step 123 as well as by means of its flange 132. The cylinder liner 130 is furthermore fixed in place by means of a cylinder head lid 117.

To cool the cylinder liner 130 during operation, a coolant space 113 that surrounds the cylinder liner 130 is provided in the cylinder housing 111. This coolant space 113 is configured directly in the cylinder housing 111, in the form of a recess, and surrounds the cylinder liner 130 only along the axial height of its sleeve 135. According to the invention, the coolant present in the coolant space 113 stands in direct contact with the sleeve 135 that surrounds the outer mantle surface 134 of the cylinder liner 130. The sleeve 135 and the inner mantle surface 121 of the coolant space 113 delimit the latter in the radial direction.

In the end result, the outer mantle surface 34, 134 of the cylinder liner is effectively protected against cavitation damage proceeding from the coolant present in the coolant space 13, 113, by means of the sleeve 35, 135 provided according to the invention.

1. Cylinder liner (30, 130) for a cylinder crankcase (11, 12; 111, 112) of an internal combustion engine, wherein at least a partial region of the outer mantle surface (34, 134) of the cylinder liner (30, 130) is surrounded by a sleeve (35, 135) that consists of a metallic material.

2. Cylinder liner according to claim 1, wherein the entire outer mantle surface (34) of the cylinder liner (30) is surrounded by a sleeve (35) that consists of a metallic material.

3. Cylinder liner according to claim 1, wherein the sleeve (35, 135) consists of a steel material.

4. Cylinder liner according to claim 1, wherein the cylinder liner (30, 130) consists of a cast-iron material.

5. Cylinder liner according to claim 1, wherein the sleeve (35) is shrunk onto the outer mantle surface (34) of the cylinder liner (30).

6. Cylinder liner according to claim 1, wherein the sleeve (135) is cast onto the outer mantle surface (134) of the cylinder liner (130).

7. Cylinder liner according to claim 1, wherein the sleeve (135) surrounds at least a partial region of the outer mantle surface (134) of the cylinder liner (130) and ends flush with the outer mantle surface (134) of the cylinder liner (130).

8. Structural unit (10, 110) consisting of at least one cylinder liner (30, 130) and a cylinder crankcase (11, 12; 111, 112) for an internal combustion engine, having at least one coolant space (13, 113) assigned to the at least one cylinder liner (30, 130), wherein at least a partial region of the outer mantle surface (34, 134) of the cylinder liner (30, 130) is surrounded by a sleeve (35, 135) that consists of a metallic material, facing the at least one coolant space (13, 113).

9. Structural unit according to claim 8, wherein the entire outer mantle surface (34) of the cylinder liner (30) is surrounded by a sleeve (35) that consists of a metallic material, facing the at least one coolant space (13).

10. Structural unit according to claim 8, wherein the sleeve (35, 135) consists of a steel material.

11. Structural unit according to claim 8, wherein the cylinder liner (30, 130) consists of a cast-iron material.

12. Structural unit according to claim 8, wherein the sleeve (135) surrounds at least a partial region of the outer mantle surface (134) of the cylinder liner (130) and ends flush with the outer mantle surface (134) of the cylinder liner (130).
